(19) United States
(12) Patent Application Publication
(10) Pub. No.: US 2014/0056438 A1
(43) Pub. Date: Feb. 27, 2014

(54) SYSTEM FOR VEHICLE SOUND SYNTHESIS

(71) Applicants: Arvin Baalu, Bangalore (IN); Anantha Krishnan, Bangalore (IN); Sharath Chandrashekar, Bangalore (IN)

(72) Inventors: Arvin Baalu, Bangalore (IN); Anantha Krishnan, Bangalore (IN); Sharath Chandrashekar, Bangalore (IN)

(73) Assignee: Harman International Industries, Incorporated, Northridge, CA (US)

(21) Appl. No.: 13/590,492

(22) Filed: Aug. 21, 2012

(51) Int. Cl. H04B 1/00

(52) U.S. Cl. 381/86

(57) ABSTRACT

A vehicle sound synthesis system may be configured to generate a vehicle sound signal tuned to an ambient condition in an area external to a vehicle. The system may detect the ambient condition, such as a weather condition, a time condition, a traffic condition, a location condition, or an ambient sound condition. The system may synthesize the vehicle sound signal, and set an acoustical parameter of the vehicle sound signal based on the ambient condition. The acoustical parameter may include a frequency, an amplitude, a phase, modulation, or a time delay. The vehicle sound signal may be indicative of operation of the vehicle. The system may drive a sound generation device to produce sound waves corresponding to the synthesized vehicle sound signal and audible in a variety of ambient conditions to alert pedestrians and/or occupants of other vehicles to the presence of the vehicle generating the sound.

### BACKGROUND OF THE INVENTION

1. Technical Field

The present disclosure relates generally to generating simulated vehicle sounds and, more particularly, to synthesizing a vehicle sound signal based on ambient conditions in an area external to a vehicle.

2. Related Art

Pedestrians and drivers are generally familiar with the sounds associated with a vehicle having an internal combustion engine. However, electric or hybrid vehicles often emit no sound or low intensity sound which may be unrecognizable by pedestrians or other drivers. This may present a safety issue, as pedestrians and other drivers may be unable to detect the presence of an electric or hybrid vehicle.

### SUMMARY

A vehicle sound synthesis system may be configured to generate a vehicle sound signal tuned to an ambient condition in an area external to a vehicle. The vehicle sound signal may be tuned so that a vehicle sound generated based on the vehicle sound signal may be audible to pedestrians and/or occupants of other vehicles in a variety of different ambient conditions. The system may detect the ambient condition. The ambient condition may include one or more of a weather condition (such as, indicative of visibility, precipitation, fog, wind, and/or light), a time condition (such as, indicative of current time), a traffic condition (such as, indicative of traffic density, traffic proximity, traffic flow, and/or traffic speed), a location condition (such as indicative of current location and/or proximity to a point of interest), or an ambient sound condition (such as indicative of a local decibel level being above a predetermined threshold). The vehicle sound synthesis system may synthesize the vehicle sound signal. The vehicle sound synthesis system may set an acoustical parameter of the vehicle sound signal based on the ambient condition. The acoustical parameter may include one or more of a frequency, an amplitude, a phase, a modulation, and/or a time delay. The vehicle sound signal may be indicative of operation of the vehicle. The vehicle sound synthesis system may drive a sound generation device of the vehicle to produce sound waves corresponding to the synthesized vehicle sound signal. The vehicle sound may be audible to the pedestrians and/or occupants of other vehicles in a variety of different ambient conditions. This may alert pedestrians and/or occupants of other vehicles to the presence of the vehicle generating the sound.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates one example of a vehicle including a vehicle sound synthesis system.

FIG. 2 is a block diagram illustrating one example of a vehicle sound synthesis system.

FIG. 3 illustrates one example of a vehicle sound synthesis device of the vehicle sound synthesis system of FIG. 2.

FIG. 4 is a flow diagram illustrating one example of operation of the vehicle sound synthesis system of FIG. 2.

### DETAILED DESCRIPTION OF THE PREFERRED EMBODIMENTS

Pedestrians, foot traffic, vehicular traffic, and/or other traffic generally may be familiar with the sounds produced by an internal combustion engine (e.g., due to repeated exposure to such sounds) and may be capable of readily identifying an approaching or nearby vehicle and/or perceiving how close the approaching or nearby vehicle is based on the sounds of the internal combustion engine and/or the exhaust. Vehicles such as electric vehicles (or hybrid vehicles) may emit no sound or limited, low intensity sounds (such as sounds produced by motors and/or fans surrounding the motors). It may be difficult or even impossible for pedestrians, foot traffic, vehicular traffic, and/or other traffic to recognize the approach, proximity, and/or departure of the electric or hybrid vehicle. This may present a safety hazard.

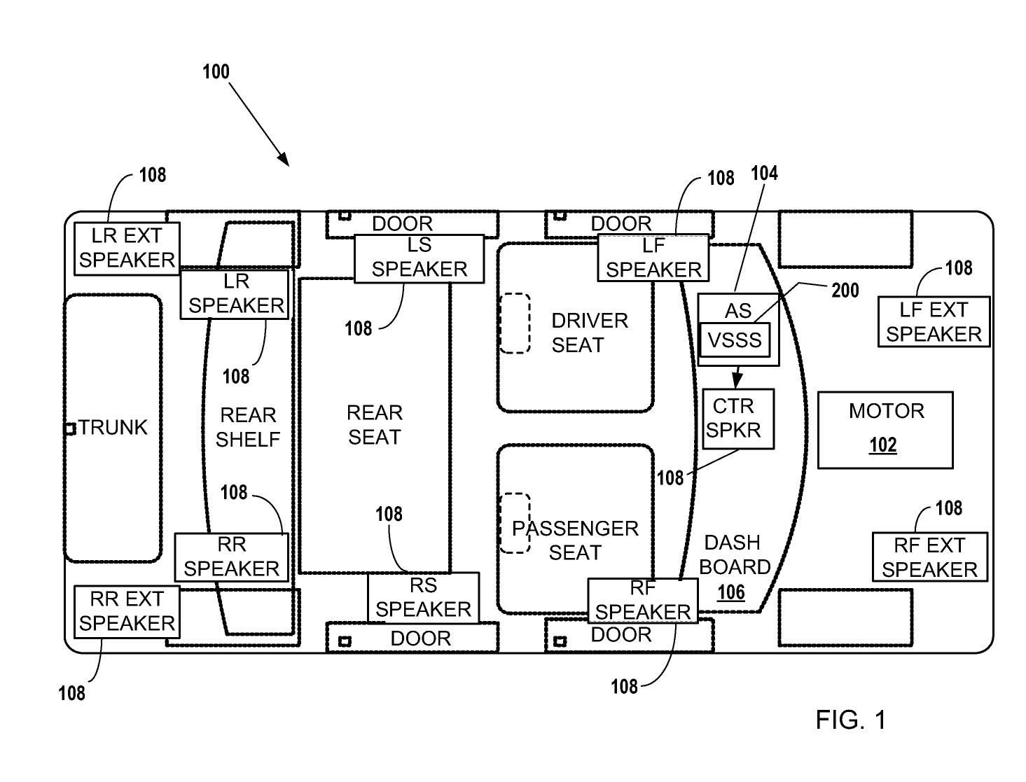

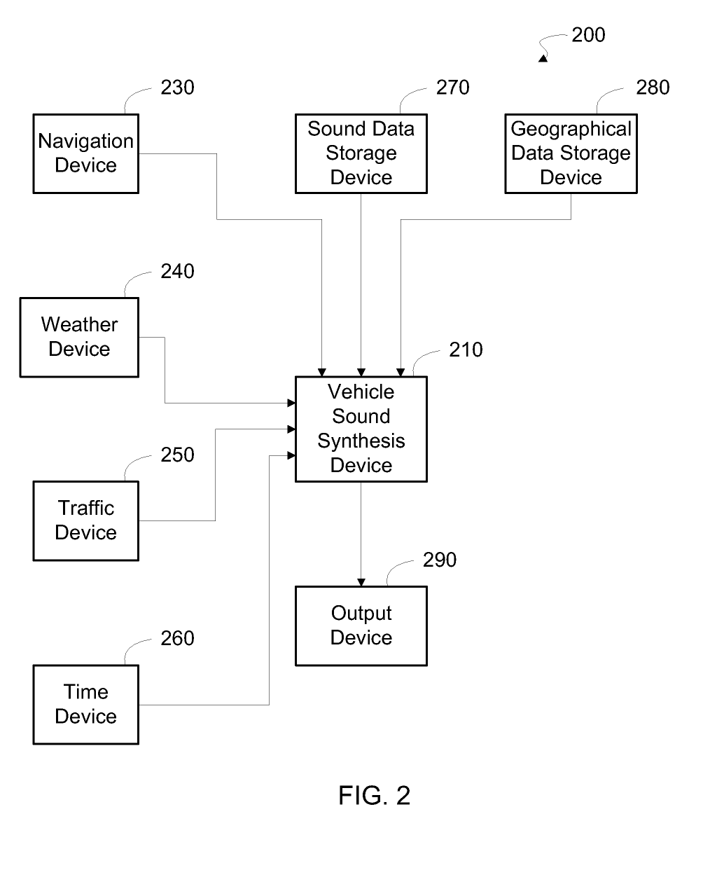

FIG. 1 illustrates one example of a vehicle 100, which may include a vehicle sound synthesis system (VSSS) 200. The vehicle sound synthesis system 200 is described in more detail later with reference to FIG. 2. The vehicle 100 may include an electric motor, an internal combustion engine, both an electric motor and an internal combustion engine, or any other propulsion system, which may produce limited or substantially little audible sound. In one example, the vehicle 100 may be a partially or fully electric vehicle. To that end, the vehicle 100 may include an electric motor 102 as shown in FIG. 1. Additionally, or alternatively, the vehicle 100 may be configured as a hybrid vehicle including both the electric motor 102 and an internal combustion engine. The motor 102 of the vehicle 100 may generate sounds which may be different than the sounds typically associated with an internal combustion engine. For example, the sounds generated by the motor 102 may have a relatively low intensity compared to the sounds generated by an internal combustion engine. In other words, the motor 102 may be quieter than an internal combustion engine.

Pedestrians and/or occupants of surrounding vehicles may be accustomed to the sounds typically associated with an internal combustion engine, and may not recognize the presence of the vehicle 100 from the sounds generated by the motor 102. The vehicle sound synthesis system 200 may be configured to simulate sounds configured to indicate operation of the vehicle 100. Such simulated sounds may be capable of alerting pedestrians and/or occupants of surrounding vehicles to the presence of the vehicle 100. This may enhance the safety of the vehicle 100 such as when driving in areas with pedestrians or other vehicles. In one example, the vehicle sound synthesis system 200 may be configured to synthesize sounds configured to simulate the sounds typically associated with operation of a vehicle being driven by an internal combustion engine. In other examples, the vehicle sound synthesis system 200 may be configured to simulate any other suitable sounds capable of indicating operation of the vehicle 100. Additionally, or alternatively, the vehicle sound synthesis system 200 may be configured to adjust the synthesized sounds based on one or more ambient conditions external to the vehicle to tune the synthesized vehicle sound to the ambient conditions as further described later.

The vehicle 100 may include an audio system 104. The audio system 104 may be positioned in a dashboard 106 of the vehicle 100 as shown in FIG. 1. The audio system 104 may include various components such as, for example, an AM/FM radio, a CD player, a cassette deck, a personal music player connector, an equalizer, an amplifier, a cellular telephone interface, a navigation system, or any other suitable components. The audio system 104 may be configured as a two channel stereo system or a multi-channel surround system such as, for example, a five, six, or seven channel surround system. The audio system 104 may include software modules, hardware modules, or a combination of software and hardware modules to process audio signals provided to a plurality of speakers 108 positioned throughout the vehicle 100. The audio system 104 may include a processor and a memory capable of supporting the vehicle sound synthesis system 200. Although the vehicle sound synthesis system 200 is illustrated in FIG. 1 as being included in the audio system 104, in other examples, the vehicle sound synthesis system 200 may be a separate standalone system that creates audible sound independent of the audio system 104, may directly drive loudspeakers 108 included in the audio system 104 to create audible sound, or may be an external system that interfaces with the audio system 104, and provides signals, such as an audio signal, to the audio system 104 for processing to create audible sound.

The speakers 108 may include a center (CTR) speaker, a right front (RF) speaker, a left front (LF) speaker, a right side (RS) speaker, a left side (LS) speaker, a right rear (RR) speaker, and a left rear (LR) speaker positioned within the cabin of the vehicle as shown in FIG. 1. Additionally, or alternatively, the vehicle 100 may include a right front external (RF EXT) speaker and/or a left front external (LF EXT) speaker positioned at the front of the vehicle outside of the passenger cabin. In one example, the right front external speaker and the left front external speaker may be positioned within the motor compartment of the vehicle 100 as shown in FIG. 1. Additionally, or alternatively, the vehicle 100 may include a right rear external (RR EXT) speaker and/or a left rear external (LR EXT) speaker positioned at the rear of the vehicle outside of the passenger cabin. In one example, the right rear external speaker and the left rear external speaker may be positioned within the trunk compartment of the vehicle 100 as shown in FIG. 1.

Any of the speakers 108 may be driven to produce sound waves corresponding to sound signals generated by the vehicle sound synthesis system 200. The external speakers may be driven to produce sound waves that are audible outside or external to the vehicle 100. The sound waves that are audible outside of the vehicle 100 may be audible or inaudible to occupants inside of the vehicle 100. In one example, sound waves emitted by the external speakers may be used to vibrate portions of the motor compartment and/or the trunk compartment of the vehicle 100. Additionally, or alternatively, electromagnetic shaker panels may be used in place of or in combination with the speakers 108. This may provide a more realistic vehicle sound to pedestrians, occupants of surrounding vehicles, and/or occupants inside the vehicle 100 by producing simulated vehicle sounds associated with vehicle components vibrating with operation of a desired engine type.

In one example, different speakers may be configured to generate different sounds. For example, one or more external speakers may be configured to generate engine sounds in response to sound signals synthesized by the vehicle sound synthesis system 200. Additionally, or alternatively, one or more internal speakers may be configured to generate other sounds such as, for example, in response to sound signals generated by the audio system 104 (such as music). In this manner, the sounds projected outside of the passenger cabin may be different than the sounds projected within the passenger cabin. This may enable the sounds projected outside of the passenger cabin to be configured to alert pedestrians and/or occupants of other vehicles to the presence of the vehicle 100.

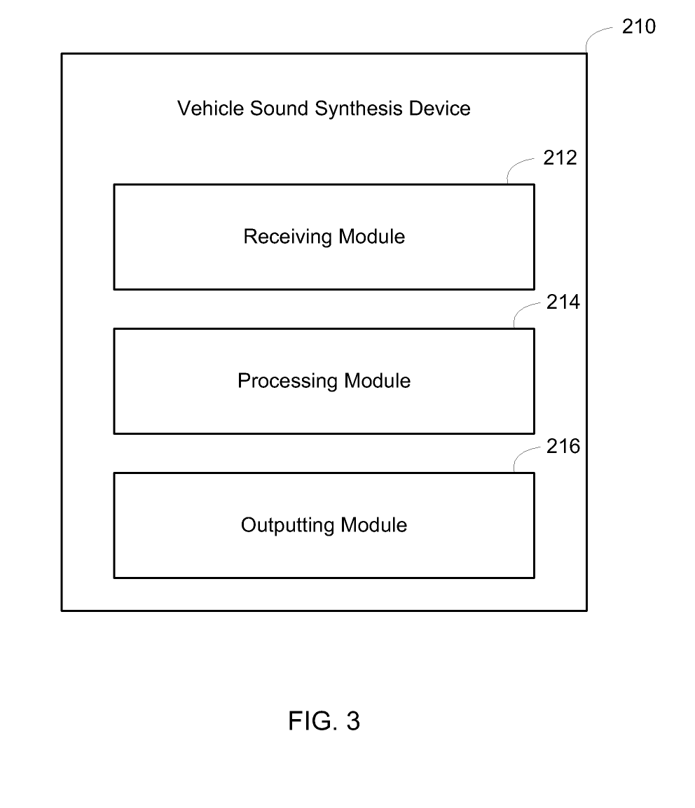

FIG. 2 is a block diagram illustrating one example of the vehicle sound synthesis system 200. The vehicle sound synthesis system 200 may include and/or be interfaced to various devices and/or systems. The vehicle sound synthesis system 200 may include a vehicle sound synthesis device 210 for synthesizing a vehicle sound signal. The vehicle sound synthesis device 210 may receive various signals (such as a navigation information signal, a weather information signal, a traffic information signal, and/or a time information signal) and/or access various types of data (such as sound data and/or geographical data) and synthesize or generate a vehicle sound signal based on the signals and/or data. The synthesized vehicle sound signal may be transmitted to an output device (such as a loudspeaker and/or a shaker panel) which may produce sound waves corresponding to the vehicle sound signal. The vehicle sound synthesis device 210 may include one or more modules as described later with reference to FIG. 3. In one example, the vehicle sound synthesis system 200 may include or be interfaced to a navigation device 230, a weather device 240, a traffic device 250, and/or a time device 260 as shown in FIG. 2. Additionally, or alternatively, the vehicle sound synthesis system 200 may include or be interfaced to a sound data storage device 270, a geographical data storage device 280, and/or an output device 290.

The navigation device 230 may be configured to detect a location condition. For example, the navigation device 230 may be configured to determine a current location of the vehicle 100 and/or to provide navigation instructions to a desired destination. To that end, the navigation device 230 may include a global positioning system (GPS) receiver or a comparable satellite-based positioning system receiver for receiving positioning signals from navigation satellites. Additionally, or alternatively, the navigation device 230 may include a positioning device configured to work with any other type of positioning system, such as a beacon system, an angle of arrival system, an arrival time system, or any combination thereof. The location condition may be an indication of the proximity of the current location of the vehicle and/or the navigation route to a point of interest as further described later.

The weather device 240 may be configured to detect a weather condition in an area external to the vehicle 100. For example, the weather device 240 may be configured to detect a visibility condition, a wind condition (such as a wind speed or a wind direction), a precipitation condition (such as a rain condition or a snow condition), a fog condition, a light condition, or any other type of weather condition. In one example, the weather device 240 may include a receiver configured to receive a weather information signal indicative of the weather condition. For example, the weather device 240 may receive a signal indicative of the weather condition via an internet connection, a cellular communications network, a satellite based weather system, an AM or FM radio based weather system, a navigation system based weather system, or any other type of weather system. In one example, the weather device 240 may be included in the navigation device 230.

The traffic device 250 may be configured to detect a traffic condition in an area external to the vehicle 100. For example, the traffic device 250 may be configured to detect a traffic density condition, a traffic proximity condition, or any other type of traffic condition. In one example, the traffic device 250 may include a receiver configured to receive a traffic information signal indicative of the traffic condition. For example, the traffic device 250 may receive a signal indicative of the traffic condition via an internet connection, a cellular communications network, a satellite based traffic system, an AM or FM radio based traffic system (e.g., using an FM radio data system (RDS) or traffic message channel (TMC) signal), a navigation system based traffic system, or any other type of traffic system. In one example, the traffic device 250 may be included in the navigation device 230.

The time device 260 may be configured to determine a current time. In one example, the time device 260 may include a clock included the vehicle 100. In other examples, the time device 260 may include a receiver configured to receive a time information signal indicative of the current time. For example, the time device 260 may receive a signal indicative of the current time via an internet connection, a cellular communications network, an AM or FM radio system, or any other type of system capable of providing a current time.

The sound data storage device 270 may be configured to store sound data for use by the vehicle sound synthesis device 210. For example, the sound data may include a sound configured to simulate operation of an internal combustion engine. Additionally, or alternatively, the sound data may include any other sound which may be accessed by the vehicle sound synthesis device 210 to synthesize a vehicle sound signal indicative of operation of the vehicle 100. In one example, the sound data storage device 270 may be configured as a sound library including a plurality of sounds which may be accessed by the vehicle sound synthesis device 210. The sounds of the sound library may be reference sounds which may be modified or adjusted based on ambient conditions external to the vehicle 100 as described later to synthesize a vehicle sound signal.

The geographical data storage device 280 may be configured to store geographical data for use by the vehicle sound synthesis device 210. For example, the geographical data may include the location of one or more points of interest, the location of a geographical region and regulatory data corresponding to the region, or any other geographical information. The points of interest may include locations such as, for example, a pedestrian crossing, a school zone, or a hospital zone. The geographical region may include a city, a town, a county, a province, a state, or any other geographical region. The regulatory data may include a permissible level of sound that may be generated by a vehicle in a geographical region. In other words, the regulatory data may include noise ordinance data for the geographical region. The locations may be stored as a latitude and a longitude, a distance and/or a direction from a reference point, or any other data configured to indicate the location (e.g., of the point of interest or the geographical region).

Any of the data storage devices described throughout this disclosure (such as the sound data storage device 270 and/or the geographical data storage device 280) may include any type of memory such as, for example, one or more of a hard disk device, a compact disc read-only memory (CD-ROM) device, a digital versatile disc (DVD) device, a random access memory (ROM) device, or any other one or more non-transitory data storage devices. Additionally, or alternatively, rewritable non-volatile memory, such as, for example, flash memory, may be provided to store data and information in a flexible way and/or to maintain the stored information even in the case of a power outage.

The output device 290 may be configured to produce sound waves corresponding to the vehicle sound signal synthesized by the vehicle sound synthesis device 210. To that end, the output device 290 may include a loudspeaker and/or a shaker panel as described earlier with reference to the speakers 108 of the vehicle 100. In one example, the output device 290 may be configured to produce sound waves audible to pedestrians and/or occupants of surrounding vehicles. To that end, the output device 290 may include one or more external speakers such as, for example, the right front external speaker, the left front external speaker, the right rear external speaker, and/or the left rear external speaker of the vehicle 100.

FIG. 3 is a block diagram of one example of the vehicle sound synthesis device 210. The vehicle sound synthesis device 210 may include a receiving module 212 configured to receive signals and/or data from other devices (such as the navigation device 230, the weather device 240, the traffic device 250, the time device 260, the sound data storage device 270, and/or the geographical data storage device 280) as described above. The vehicle sound synthesis device 210 may include a processing module 214 configured to employ vehicle sound synthesis logic to synthesize a sound signal based on the received signals and/or data. The processing module 214 may be configured as a general processor, a digital signal processor, an application specific integrated circuit, a field programmable gate array, an analog circuit, a digital circuit, a server processor, combinations thereof, or other now known or later developed processor. The processing module 214 may be configured as a single device or a combination of devices, such as associated with a network or distributed processing. Any of various processing strategies may be used, such as multi-processing, multi-tasking, parallel processing, remote processing, centralized processing or the like. The processing module 214 may be responsive to or operable to execute instructions stored as part of software, hardware, integrated circuits, firmware, microcode, or the like. The vehicle sound synthesis device 210 may include an outputting module 216 configured to output a synthesized vehicle sound signal to the output device 290.

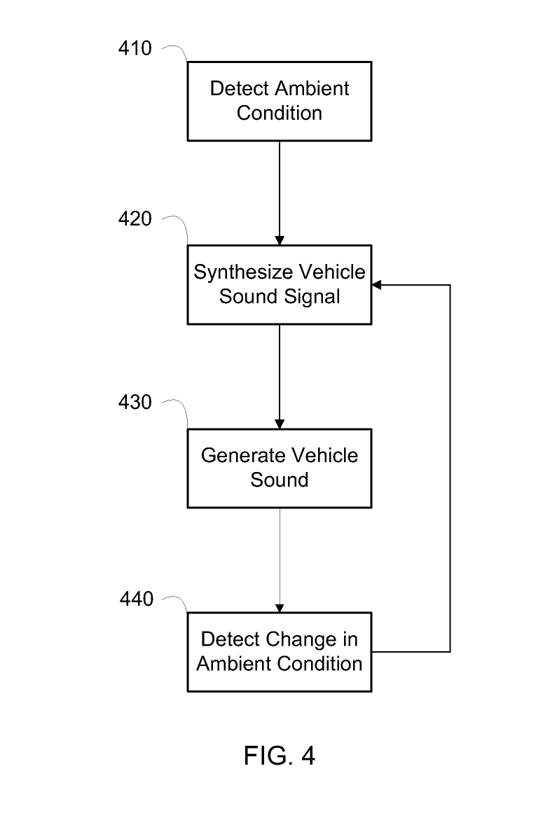

FIG. 4 is a flowchart illustrating one example of operation of the vehicle sound synthesis system 200. At step 410, an ambient condition may be detected. The ambient condition may be indicative of the condition of the area external to the vehicle 100. The area external to the vehicle may be an area generally surrounding or nearby the vehicle. The ambient condition may include, for example, one or more of a location condition, a weather condition, a traffic condition, or a time condition as further described later. At step 420 a vehicle sound signal may be synthesized. The vehicle sound signal may be synthesized based on or in response to the detected ambient condition. At step 430, a vehicle sound corresponding to the synthesized vehicle sound signal may be generated, for example, by the output device 290. In other words, sound waves corresponding to the synthesized vehicle sound signal and based on the detected ambient condition may be generated by the output device 290. At step 440, a change in the ambient condition may be detected. In response to detection of the change in the ambient condition, a vehicle sound signal may be synthesized based on the changed ambient condition at step 420, and a vehicle sound corresponding to the synthesized vehicle sound signal may be generated at step 430. In other words, upon detection of the change in the ambient condition, the synthesized vehicle sound signal may be adjusted based on the changed ambient condition, and the sound waves generated by the output device 290 may be adjusted to correspond to the adjusted vehicle sound signal. In this manner, the vehicle sound signal synthesized by the vehicle sound synthesis device 210 and the vehicle sound generated by the output device 290 may be adjusted based on changes in the ambient condition.

The vehicle sound signal may include a plurality of acoustical properties. Synthesizing the vehicle sound signal may include setting or selecting the value of one or more of the acoustical properties to synthesize the vehicle sound signal having the desired acoustical properties. The value of one or more of the acoustical properties may be adjusted based on changes in the ambient condition to tune the vehicle sound signal to the ambient condition. The acoustical properties may include, for example, a frequency, an amplitude, a phase, a modulation (such as variation of the signal with respect to time), and/or a time delay (such as a time delay between the onset of different frequencies). By adjusting the acoustical properties of the vehicle sound signal based on the ambient condition, the vehicle sound generated by the output device 290 may be configured to be audible under a variety of different ambient conditions. In other words, the vehicle sound generated by the output device 290 may be tuned to the ambient condition.

In one example, the ambient condition may be a location condition. The location condition may be an indication of the proximity of the current position of the vehicle to a point of interest. For example, the location condition may be an indication that the current position of the vehicle is within a predetermined distance of a point of interest (such as a pedestrian crossing, a school zone, a hospital, or any other point of interest). In other words, the location condition may be an indication that the distance between the current position of the vehicle 100 and the point of interest is less than a predetermined distance threshold. Additionally, or alternatively, the location condition may be an indication of the proximity of the navigation route of the vehicle to a point of interest.

In one example, the point of interest may be a location where an expected concentration of traffic is relatively high. In other words, the expected concentration of traffic may exceed a threshold concentration of traffic value at the point of interest. For example, the point of interest may be a school zone or a pedestrian crossing, where the expected concentration of pedestrian traffic (such as foot traffic) may be high. The vehicle sound synthesis system 200 may be configured to adjust the vehicle sound signal (such as by increasing the amplitude and/or the frequency) in response to the high expected concentration of traffic at the school zone or pedestrian crossing. In this manner, the vehicle sound generated by the vehicle sound synthesis system 200 may be made more audible to the pedestrians expected in the school zone or pedestrian crossing to alert the pedestrians to the presence of the vehicle 100.

The location condition may be detected by the navigation device 230. The vehicle sound synthesis device 210 may receive a navigation signal indicative of the detected location condition from the navigation device 230. Alternatively, the vehicle sound synthesis device 210 may receive a location signal indicative of the current position of the vehicle 100 from the navigation device 230. The vehicle sound synthesis device 210 may retrieve the location of one or more points of interest from the geographical data storage device 280. The vehicle sound synthesis device 210 may compare the current position of the vehicle 100 to the retrieved locations of the points of interest to determine whether the vehicle is within the predetermined distance of a point of interest. In other words, the vehicle sound synthesis device 210 may compare the current position of the vehicle 100 to the retrieved locations of the points of interest to detect the location condition. The vehicle sound synthesis system 200 may adjust the vehicle sound based on the detected location condition. In other words, the vehicle sound synthesis system 200 may be configured to adjust the synthesized vehicle sound signal and thus the generated vehicle sound based on the detected location condition.

In another example, the ambient condition may be a weather condition. The weather condition may include a visibility condition, a wind condition (such as a wind speed or a wind direction), a precipitation condition (such as a rain condition or a snow condition), a fog condition, a light condition, or any other type of weather condition. The visibility condition may be an indication of a distance at which an object or light can be clearly discerned in the area external to the vehicle 100. The wind condition may be an indication of the speed, direction, or other property of the wind in the area external to the vehicle 100. The precipitation condition may be an indication of the presence of any type of precipitation such as, for example, drizzle, mist, rain, sleet, snow, graupel, or hail in the area external to the vehicle 100. The fog condition may be an indication of the presence of fog, or a collection of liquid water droplets or ice crystals suspended in the air, in the area external to the vehicle 100. The light condition may be an indication of the intensity or brightness of light (such as sunlight) in the area external to the vehicle 100. In one example, the intensity of the light may be detected by a photodetector device included in the vehicle 100.

In one example, the weather condition may indicate that pedestrians and/or occupants of surrounding vehicles may have difficulty seeing and/or hearing the vehicle 100 (e.g., due to low visibility caused by, for example, precipitation, fog, and/or low light conditions or due to noise caused by precipitation or wind). The vehicle sound synthesis system 200 may be configured to adjust the vehicle sound signal (such as by increasing the amplitude and/or the frequency) in response to the low visibility or high noise conditions. In this manner, the vehicle sound generated by the vehicle sound synthesis system 200 may be made more audible to the pedestrians and/or occupants of surrounding vehicles to alert them to the presence of the vehicle 100.

The weather condition may be detected by the weather device 240. The vehicle sound synthesis device 210 may receive a weather signal indicative of the detected weather condition from the weather device 240. The vehicle sound synthesis system 200 may adjust the vehicle sound based on the detected weather condition. In other words, the vehicle sound synthesis system 200 may be configured to adjust the synthesized vehicle sound signal and thus the generated vehicle sound based on the detected weather condition.

In another example, the ambient condition may be a traffic condition. The traffic condition may include a traffic density condition, a traffic proximity condition, a traffic flow condition, a traffic speed condition, or any other type of traffic condition. The traffic density condition may be an indication of the number of vehicles per unit area of the roadway in the area external to the vehicle 100. The traffic proximity condition may be an indication of the spacing between the vehicle 100 and one or more surrounding vehicles. In one example, the vehicle sound synthesis system may include a proximity sensor (such as an ultrasonic proximity sensor) configured to detect the traffic proximity condition. Additionally, or alternatively, the vehicle sound synthesis system may include an imaging device (such as a camera) configured to detect the traffic proximity condition. In other words, the proximity sensor and/or imaging device may detect the presence of an object (such as a pedestrian or a vehicle) in proximity to the vehicle 100. The proximity sensor may be a component of another system such as, for example, a park distance control system of the vehicle 100. Additionally, or alternatively, the imaging device may be a component of another system such as, for example, a park assistance system, a lane guidance system, a collision warning system, or any other system of the vehicle 100. The traffic flow condition may be an indication of the number of vehicles passing a reference point per unit of time in the area external to the vehicle 100. The traffic speed condition may be an indication of the distance covered by the traffic in a unit of time in the area external to the vehicle 100.

In one example, the traffic condition may indicate the presence of traffic (such as foot traffic and/or vehicular traffic) in the area external to the vehicle 100. The vehicle sound synthesis system 200 may be configured to adjust the vehicle sound signal (such as by increasing the amplitude and/or the frequency) in response to the presence of traffic in proximity to the vehicle 100. In this manner, the vehicle sound generated by the vehicle sound synthesis system 200 may be made more audible to the pedestrians and/or occupants of surrounding vehicles to alert them to the presence of the vehicle 100. For example, the adjusted vehicle sound may be audible to the pedestrians and/or occupants of surrounding vehicles over the sounds generated by the traffic in the area external to the vehicle 100. Additionally, or alternatively, the adjusted vehicle sound may be configured to attract the attention of pedestrians and/or occupants of other vehicles who may be distracted by the traffic in the area external to the vehicle 100.

The traffic condition may be detected by the traffic device 250. The vehicle sound synthesis device 210 may receive a traffic signal indicative of the detected traffic condition from the traffic device 250. The vehicle sound synthesis system 200 may adjust the vehicle sound based on the detected traffic condition. In other words, the vehicle sound synthesis system 200 may be configured to adjust the synthesized vehicle sound signal and thus the generated vehicle sound based on the detected traffic condition.

In another example, the ambient condition may be a time condition. The time condition may be an indication of the current time at the current location of the vehicle 100. For example, the time condition may be an indication that the current time is later than the sunset time and earlier than the sunrise time at the current location of the vehicle. In other words, the time condition may be an indication that it is nighttime at the current location of the vehicle. Alternatively, the time condition may be an indication that the current time is later than the sunrise time and earlier than the sunset time at the current location of the vehicle, or that it is daytime at the current location of the vehicle. In another example, the time condition may be an indication that the current time falls within a time period when pedestrian and/or vehicular traffic tends to be relatively high (such as during rush hour) or within a time period when pedestrian and/or vehicular traffic tends to be relatively low. In another example, the time condition may be an indication that the current time falls within a time period during which generation of sounds or noise may be restricted. For example, generation of sounds exceeding a certain intensity level (or decibel level) may be prohibited during determined hours of the night in some locations.

The time condition may be detected by the time device 260. The vehicle sound synthesis device 210 may receive a time signal indicative of the detected time condition from the time device 260. The vehicle sound synthesis system 200 may adjust the vehicle sound generated based on the detected time condition. In other words, the vehicle sound synthesis system 200 may be configured to adjust the synthesized vehicle sound signal and thus the generated vehicle sound based on the detected time condition.

In another example, the ambient condition may be an ambient sound condition. The ambient sound condition may be an indication of a local decibel level in the area external to the vehicle 100. For example, the ambient sound condition may be an indication that the local decibel level is above a predetermined threshold. The local decibel level may be an indication of ambient sound generated by, for example, traffic (such as vehicular traffic, construction traffic, or any other type of traffic), weather (such as rain, sleet, wind, thunder, or any other weather condition), or any other sound generating condition. The ambient sound condition may be detected by a sound detection device such as, for example, a microphone. The vehicle sound synthesis device 210 may receive an ambient sound signal indicative of the detected ambient sound condition from the sound detection device. The vehicle sound synthesis system 200 may adjust the vehicle sound generated based on the detected ambient sound condition. In other words, the vehicle sound synthesis system 200 may be configured to adjust the synthesized vehicle sound signal and thus the generated vehicle sound based on the detected ambient sound condition.

The vehicle sound synthesis system 200 may be configured to simulate sounds associated with operation of a vehicle being driven by an internal combustion engine. Additionally, or alternatively, the vehicle sound synthesis system 200 may be configured to simulate sounds associated with operation of other types of vehicles such as, for example, a jet, a motorboat, a carriage, a rocket, a spaceship, or any other type of vehicle. Additionally, or alternatively, the vehicle sound synthesis system 200 may be configured to simulate any other type of sound (such as sound effects, animal sounds, or any other sound).

The vehicle sound generated by the vehicle sound synthesis system 200 may be configured to indicate operation of the vehicle 100. In other words, the vehicle sound may be configured to indicate that the vehicle 100 is prepared to move or actually moving. To that end, the method illustrated in FIG. 4 may be initiated by operation of the vehicle 100 (e.g., by activating the ignition of the vehicle 100 or by putting the vehicle 100 in gear as further described later). This may alert pedestrians and/or occupants of surrounding vehicles to the presence of the vehicle 100 in a manner similar to the manner in which they are alerted to the presence of a vehicle driven by an internal combustion engine (such as by the sounds generated upon starting the internal combustion engine).

The vehicle sound generated by the vehicle sound synthesis system 200 may be configured as a substantially continuous sound or a substantially continuous pattern of sounds generated during operation of the vehicle 100. In one example, the vehicle sound may be generated during operation of the vehicle regardless of the ambient condition. In other words, the vehicle sound may be generated without regard to the ambient condition (such as traffic proximity) while one or more acoustical properties of the vehicle sound may be adjusted based on the ambient condition as described herein. In one example, the sound may be generated in response to the ignition of the vehicle 100 being switched on and/or the vehicle 100 being in gear (i.e., not in park). Because the vehicle 100 may be capable of moving any time it is on and/or in gear, the vehicle sound may alert pedestrians and/or occupants of other vehicles in the area external to the vehicle 100 that the vehicle 100 may begin moving at any time. In another example, the vehicle 100 may include both the motor 102 and an internal combustion engine (e.g., the vehicle 100 may be configured as a hybrid vehicle), and the vehicle sound may be generated in response to the vehicle 100 being on and/or in gear and the internal combustion engine being stopped (i.e., not running) In other words, the vehicle sound synthesis system may be configured to interrupt or prevent generation of the vehicle sound when the internal combustion engine is running Because the internal combustion engine may produce sounds recognizable by pedestrians and/or occupants of other vehicles in the area external to the vehicle 100, generation of the vehicle sound by the vehicle sound synthesis system 200 may be unnecessary during operation of the internal combustion engine. In other words, the pedestrians and/or occupants of other vehicles may be able to detect the presence of the vehicle 100 by the sounds generated by the internal combustion engine. The vehicle sound synthesis system 200 may enable generation of the vehicle sound in response to the internal combustion engine being stopped (such as when the hybrid vehicle switches to electric power or a cruising mode).

In one example, synthesizing the vehicle sound signal may include retrieving a reference vehicle sound signal. For example, the vehicle sound synthesis device 210 may retrieve a reference vehicle sound signal stored in the sound data storage device 270. The reference vehicle sound signal may be configured to simulate operation of an internal combustion engine. In other examples, the reference vehicle sound signal may be configured to simulate operation of any other type of engine or vehicle or to simulate any other type of sound as described earlier. The reference vehicle sound signal may include acoustical parameters as described earlier. The acoustical properties of the reference vehicle sound signal may be tuned for a reference ambient condition. For example, the acoustical properties of the reference vehicle sound signal may be tuned for a clear day (such as daytime conditions with no precipitation and high visibility) with low traffic (such as substantially no traffic in the area immediately surrounding the vehicle 100). In other examples, the reference ambient condition may include any other ambient conditions (such as location condition, weather condition, traffic condition, and/or time condition). Passing the reference vehicle sound signal to the output device 290 (e.g., without modifying the reference vehicle sound signal) may generate a reference vehicle sound. Synthesizing the vehicle sound signal may include adjusting one or more acoustical parameters of the reference vehicle sound signal based on the detected ambient condition to synthesize or generate the vehicle sound signal. In other words, the synthesized vehicle sound signal may be synthesized by adjusting one or more acoustical parameters of the reference vehicle sound signal based on the detected ambient condition.

In one example, the reference vehicle sound signal may be configured as a relatively low energy sound signal. In other words, the acoustical properties of the reference vehicle sound signal may be selected so that generation of the reference vehicle sound may require a relatively low amount of power from the vehicle 100. Generating the vehicle sound signal (i.e., after adjusting the acoustical properties of the reference vehicle sound signal) may require a higher amount of power from the vehicle 100 than generating the reference vehicle sound. In this manner, the vehicle sound synthesis system 200 may be configured to generate the relatively lower power reference vehicle sound by default and to generate the relatively higher power vehicle sound signal in response to the detected ambient condition. In other words, the vehicle sound synthesis system 200 may be configured to generate the relatively higher power vehicle sound signal in response to an ambient condition in which such a sound may be beneficial for alerting pedestrians and/or occupants of surrounding vehicles to the presence of the vehicle 100 (such as when the ambient condition indicates that it may be difficult to see and/or hear the vehicle 100 or that there may be traffic in the area external to the vehicle 100). This may reduce the total power consumption of the vehicle sound synthesis system 200 relative to a system generating a relatively higher power vehicle sound regardless of the ambient condition. In other words, generating the lower power reference vehicle sound except when the ambient condition indicates that the higher power vehicle sound should be generated may reduce the total power consumption of the vehicle sound synthesis system 200. Such reduced power consumption may be beneficial in a partially or fully electric vehicle to increase the range and/or decrease the fuel consumption of the vehicle.

In one example, the retrieved reference sound signal may be based on the ambient condition. For example, the sound data storage device 270 may store a plurality of reference sound signals. Each reference sound signal may be configured to simulate operation of a different engine type or a different vehicle type. In other examples, each reference sound signal may be configured to simulate any type of different sound. The vehicle sound synthesis device 210 may retrieve one of the plurality of reference sound signals based on the ambient condition. For example, the ambient condition may be a precipitation condition indicative of the presence of rain in the area external to the vehicle 100. The retrieved reference sound signal may be one of the retrieved reference sound signals configured to simulate operation of a motorboat. In other words, the retrieved reference sound signal may be a reference sound signal configured to simulate operation of a motorboat in response to the ambient condition being indicative of the presence of rain in the area external to the vehicle 100. In another example, the ambient condition may be a fog condition indicative of the presence of fog in the area external to the vehicle 100, and the retrieved reference sound signal may be a reference sound signal configured to simulate operation of an airplane in response to the ambient condition being indicative of the presence of fog. In other examples, any reference sound signal may be selected in response to any ambient condition.

Synthesizing the vehicle sound signal may include modifying or adjusting at least one acoustical parameter of the retrieved reference sound signal in response to the ambient condition. For example, the acoustical parameter of the reference sound signal may be an amplitude of the signal. The amplitude of the signal may correspond generally to the volume (e.g., the loudness or the intensity) of the vehicle sound generated by the output device 290. The vehicle sound system 200 may include an amplifier configured to adjust the gain or the amplitude of the synthesized vehicle sound signal. In one example, the ambient condition may be a traffic condition indicative of high traffic density in the area external to the vehicle 100. In other words, the traffic condition may be indicative of a traffic density in the area external to the vehicle 100 being greater than a predetermined traffic density threshold. The vehicle sound synthesis device 210 may increase the amplitude of the retrieved reference sound signal in response to the traffic condition indicative of high traffic density to generate the synthesized vehicle sound signal. In other words, the synthesized vehicle sound signal may have an increased amplitude relative to the retrieved reference sound signal in response to the traffic condition indicative of high traffic density. This may cause the vehicle sound corresponding to the synthesized vehicle sound signal and generated by the output device 290 to have a higher intensity or volume than a vehicle sound corresponding to the reference sound signal. The higher intensity or volume of the vehicle sound may aid in making the vehicle sound audible over the other traffic to aid in alerting pedestrians and/or occupants of surrounding vehicles to the presence of the vehicle 100.

In another example, the ambient condition may be an ambient sound condition indicative of ambient sound (such as caused by traffic, weather, construction, or any other source of ambient sound) being above a threshold decibel level. The vehicle sound synthesis device 210 may adjust the retrieved reference signal (such as by increasing the amplitude and/or increasing the frequency) in response to the ambient sound condition to generate the synthesized sound signal. This may aid in making the vehicle sound audible over the ambient sound to aid in alerting pedestrians and/or occupants of surrounding vehicles to the presence of the vehicle 100.

In another example, the acoustical parameter of the reference sound signal may be the amplitude of the signal, and the ambient condition may be a visibility condition indicative of low visibility. In other words, the visibility condition may be indicative of the visibility in the area external to the vehicle 100 being less than a predetermined visibility threshold. The vehicle sound synthesis device 210 may increase the amplitude of the retrieved reference signal in response to the visibility condition indicative of low visibility to generate the synthesized sound signal. This may cause the vehicle sound corresponding to the synthesized sound signal to have a higher intensity or volume than a vehicle sound corresponding to the reference sound signal. The higher intensity or volume of the vehicle sound may aid in alerting pedestrians and/or occupants of surrounding vehicles to the presence of the vehicle 100, which may be difficult or impossible to see in the low visibility conditions.

In another example, the acoustical parameter of the reference sound signal may be the amplitude of the signal, and the ambient condition may be a time condition indicating that it is nighttime at the current location of the vehicle. The vehicle sound synthesis device 210 may decrease the amplitude of the retrieved reference signal in response to the time condition indicative of nighttime to generate the synthesized vehicle sound signal. This may cause the vehicle sound corresponding to the synthesized vehicle sound signal to have a lower intensity or volume than a vehicle sound corresponding to the reference sound signal. The vehicle sound having the lower intensity or volume may be sufficient given the reduced number of pedestrians that may be likely to be present in the area external to the vehicle during nighttime hours. In other words, the lower intensity vehicle sound may be suitable for night driving conditions. The lower intensity or volume of the generated vehicle sound may avoid disturbing others present in the area external to the vehicle or violating noise restrictions which may be in place.

Additionally, or alternatively, lowering the intensity or volume of the generated vehicle sound may aid in reducing power consumption of the vehicle sound synthesis system 200. In other words, the vehicle sound synthesis system 200 may use less power to generate a lower intensity sound than to generate a higher intensity sound. Such reduced power consumption may be desirable in electric or partially electric (or hybrid) vehicles in which reduced power consumption may enable increased range and/or reduced fuel consumption.

In another example, the acoustical parameter of the reference sound signal may be the amplitude of the signal, and the ambient condition may be a location condition indicating that the current location of the vehicle 100 is in close proximity to a school zone. The vehicle sound synthesis device 210 may increase the amplitude of the retrieved reference signal in response to the location condition indicative of proximity to the school zone to generate the synthesized vehicle sound signal. This may cause the vehicle sound corresponding to the synthesized vehicle sound signal to have a higher intensity or volume than a vehicle sound corresponding to the reference sound signal. The higher intensity or volume of the vehicle sound may aid in alerting pedestrians (e.g., students) which may be present and/or crossing the street in the school zone to the presence of the vehicle 100.

In another example, the acoustical parameter of the reference sound signal may be the amplitude of the signal, and the ambient condition may be a location condition indicating that the current location of the vehicle 100 is in a geographical region having a regulation regarding the permissible sound level that may be generated by a vehicle (e.g., a noise ordinance). The vehicle sound synthesis device 210 may compare the intensity or volume of the vehicle sound to the allowed level and decrease the amplitude of the retrieved reference signal in response to the intensity or volume of the generated sound signal being greater than the allowed level to generate the synthesized vehicle sound signal. This may cause the vehicle sound corresponding to the synthesized vehicle sound signal to have a lower intensity or volume than the allowed level to ensure compliance with the local regulations. In other words, the vehicle sound synthesis system 200 may set the amplitude of the vehicle sound signal to a value such that the generated vehicle sound will have an intensity or volume that is less than that permitted by the regulation.

In any of the examples described herein, the synthesized vehicle sound signal may depend on the speed of the vehicle 100. For example, the magnitude of the adjustment of the reference sound signal (such as the increase or decrease in the amplitude and/or the frequency) may be based on the speed of the vehicle. In one example, the adjusted amplitude of the vehicle sound signal may be greater when the speed of the vehicle exceeds a predetermined speed threshold than when the speed of the vehicle fails to exceed the predetermined speed threshold. In other words, the vehicle sound may be louder when the speed of the vehicle exceeds the predetermined speed threshold than when the speed of the vehicle fails to exceed the predetermined speed threshold. This may aid in alerting pedestrians and/or occupants of surrounding vehicles to the presence of the vehicle 100 in sufficient time to react to the presence of the vehicle 100. For example, the louder vehicle sound may be audible to pedestrians and/or occupants of surrounding vehicles a greater period of time before the vehicle 100 reaches the pedestrians and/or other vehicles than a quieter vehicle sound.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for synthesizing a vehicle sound in an audio system of a vehicle, the method comprising:
receiving a signal indicative of an ambient condition in an area external to the vehicle;
synthesizing a vehicle sound signal indicative of operation of the vehicle;
setting an acoustical parameter of the vehicle sound signal based on the ambient condition; and
driving a sound generation device of the vehicle to produce sound waves corresponding to the synthesized vehicle sound signal.

2. The method of claim 1, where the ambient condition comprises at least one of a weather condition, a time condition, a traffic condition, a location condition, or an ambient sound condition.

3. The method of claim 2, where the ambient condition is the weather condition, and the weather condition comprises at least one of a visibility condition, a precipitation condition, a fog condition, a wind condition, or a light condition.

4. The method of claim 2, where the ambient condition is the traffic condition, and the traffic condition comprises at least one of a traffic density condition, a traffic proximity condition, a traffic flow condition, or a traffic speed condition.

5. The method of claim 1, where setting an acoustical parameter of the vehicle sound signal comprises retrieving a reference sound signal from a sound library and adjusting the reference sound signal based on the ambient condition to set the acoustical parameter of the vehicle sound signal.

6. The method of claim 5, where adjusting the reference sound signal comprises adjusting at least one acoustical parameter of the reference sound signal based on the ambient condition to set the acoustical parameter of the vehicle sound signal.

7. The method of claim 1, further comprising detecting a change in the ambient condition, adjusting the synthesized vehicle sound signal in response to the detected change in the ambient condition, and driving the sound generation device of the vehicle to produce sound waves in response to the adjusted vehicle sound signal.

8. The method of claim 1, where the acoustical parameter of the vehicle sound signal comprises at least one of a frequency, an amplitude, a phase, a modulation, or a time delay.

9. A vehicle sound synthesis system for synthesizing a vehicle sound in an audio system of a vehicle, the system comprising:
a detection device configured to detect an ambient condition in an area external to the vehicle;
a vehicle sound synthesis device configured to synthesize a vehicle sound signal indicative of operation of the vehicle and to set an acoustical parameter of the vehicle sound signal in response to the detected ambient condition; and
a sound generation device configured to produce sound waves corresponding to the synthesized vehicle sound signal.

10. The vehicle sound synthesis system of claim 9, where the detection device comprises at least one of a location detection device, a weather detection device, a traffic detection device, a time detection device, or a sound detection device.

11. The vehicle sound synthesis system of claim 9, where the acoustical parameter of the vehicle sound signal comprises at least one of a frequency, an amplitude, a phase, a modulation, or a time delay.

12. The vehicle sound synthesis system of claim 9, where the vehicle sound signal is synthesized in response to an ignition of the vehicle being activated.

13. The vehicle sound synthesis system of claim 9, where synthesis of the vehicle sound signal is interrupted in response to an internal combustion engine of the vehicle being activated.

14. The vehicle sound synthesis system of claim 9, further comprising a sound data storage device, where the vehicle sound synthesis device is configured to retrieve a reference sound signal from the sound data storage device and adjust at least one acoustical parameter of the reference sound signal in response to the detected ambient condition to set the acoustical parameter of the vehicle sound signal.

15. The vehicle sound synthesis system of claim 14, where the ambient condition comprises a traffic condition indicative of a traffic density that is greater than a predetermined traffic density threshold value, the acoustical parameter of the reference sound signal comprises an amplitude, and the vehicle sound synthesis device is configured to increase the amplitude of the reference sound signal in response to the traffic condition to set the acoustical parameter of the vehicle sound signal.

16. The vehicle sound synthesis system of claim 14, where the ambient condition comprises a weather condition indicative of a visibility that is less than a predetermined visibility threshold value, the acoustical parameter of the reference sound signal comprises an amplitude, and the vehicle sound synthesis device is configured to increase the amplitude of the reference sound signal in response to the weather condition to set the acoustical parameter of the vehicle sound signal.

17. The vehicle sound synthesis system of claim 14, where the ambient condition comprises a time condition indicative of a nighttime condition, the acoustical parameter of the reference sound signal comprises an amplitude, and the vehicle sound synthesis device is configured to decrease the amplitude of the reference sound signal in response to the time condition to set the acoustical parameter of the vehicle sound signal.

18. The vehicle sound synthesis system of claim 14, where the ambient condition comprises a location condition indicative of a distance between the vehicle and a point of interest being less than a predetermined distance threshold, the acoustical parameter of the reference sound signal comprises an amplitude, and the vehicle sound synthesis device is configured to increase the amplitude of the reference sound signal in response to the location condition to set the acoustical parameter of the vehicle sound signal.

19. The vehicle sound synthesis system of claim 18, where the point of interest comprises at least one of a pedestrian crossing or a school zone.

20. The vehicle sound synthesis system of claim 9, where the sound waves are directed outside of the vehicle to alert others in the area external to the vehicle to the presence of the vehicle.

21. The vehicle sound synthesis system of claim 9, where the vehicle sound synthesis device is configured to set the acoustical parameter of the vehicle sound signal to reduce a power consumption of the vehicle sound synthesis system in response to the detected ambient condition.

22. A computer readable storage medium encoded with computer executable instructions, the computer executable instructions executable with a processor, the computer readable storage medium comprising:
instructions executable to receive a signal indicative of an ambient condition in an area external to a vehicle;
instructions executable to synthesize a vehicle sound signal indicative of operation of the vehicle;
instructions executable to set an acoustical parameter of the vehicle sound signal based on the ambient condition; and
instructions executable to drive a sound generation device of the vehicle to produce sound waves corresponding to the synthesized vehicle sound signal.
